(19) United States
(12) Patent Application Publication
(10) Pub. No.: US 2023/0138280 A1
(43) Pub. Date: May 4, 2023

(54) ACTIVE OPTICAL FIBER WITH LOW BIREFRINGENCE

(71) Applicant: Ampliconyx Oy, Tampere (FI)

(72) Inventors: Valery FILIPPOV, Tampere (FI); Yury CHAMOROVSKIY, Fryazino, Moscow Region (RU)

(21) Appl. No.: 17/918,442

(22) PCT Filed: Jan. 29, 2020
(86) PCT No.: PCT/FI2020/050048

§ 371 Date: Oct. 12, 2022

(51) Int. Cl. H01S 3/067

(52) U.S. Cl. CPC H01S 3/06712; H01S 3/06745

(57) ABSTRACT

Various example embodiments relate to active optical fibers and devices comprising active optical fibers. A section of an active optical fiber may comprise an active core doped with at least one rare-earth element. The active core may have a first refractive index and be configured to support a single mode operation of an optical signal. The section of the active optical fiber may further comprise at least one cladding layer having a second refractive index. The second refractive index may be less than the first refractive index. Birefringence of the active core may be less than 10⁻⁵. Fiber lasers and power amplifiers comprising the section of the active optical fiber are also disclosed.

### TECHNICAL FIELD

Various example embodiments generally relate to the field of active optical fibers and devices using active optical fibers. In particular, some example embodiment relate to improving stability of state of polarization in active optical fibers.

### BACKGROUND

Fiber laser and amplifier technology may be used in various applications. In some applications, the state of polarization (SOP) of an output radiation of an active optical fiber is desired to be stable. An ideal active optical fiber does not distort the state of polarization. However, a real fiber may be bent and be subject to various environmental influences that may cause an unstable state of polarization.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments provide a section of active optical fiber that enables to have a sufficiently stable state of polarization regardless of internal heating of the active optical fiber during operation. Further implementation forms are provided in the dependent claims, the description, and the drawings.

According to a first aspect, a section of an active optical fiber may comprise an active core. The active core may be doped with at least one rare-earth element. The active core may have a first refractive index. The active core may be configured to support a single mode operation of an optical signal. The section of the active optical fiber may further comprise at least one cladding layer having a second refractive index. The second refractive index may be less than the first refractive index. Birefringence of the active core may be less than 10⁻⁵.

According to a second aspect an apparatus may comprise the section of the active optical fiber according to the first aspect. The apparatus may further comprise at least one pump radiation source optically connected to at least one pump radiation coupler. The pump radiation coupler may be configured couple radiation from the pump radiation source to the active optical fiber. The apparatus may be embodied for example as a fiber laser or a fiber master oscillator power amplifier (MOPA).

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a model of an ideal optical fiber, according to an example embodiment.

FIG. 2 illustrates an example of a real optical fiber, according to an example embodiment.

FIG. 3 illustrates an example of a temperature of an active optical fiber with respect to pump power, according to an example embodiment.

FIG. 4 illustrates an example of an experiment for measuring polarization stability.

FIG. 5 illustrates an example of polarization stability and temperature with respect to pump power for a PANDA type active optical fiber.

FIG. 6 illustrates an example of polarization extinction rate with respect to pump power for a PANDA type active optical fiber.

FIG. 7 illustrates an example of polarization stability and temperature with respect to pump power for a spun active optical fiber having low birefringence, according to an example embodiment.

FIG. 8 illustrates an example of polarization extinction rate with respect to pump power for a spun active optical fiber having low birefringence, according to an example embodiment.

FIG. 9 illustrates an example of a section of an active single-clad optical fiber, according to an example embodiment.

FIG. 10 illustrates an example of a section of an active double-clad optical fiber, according to an example embodiment.

FIG. 11 illustrates an example of a section of an active tapered single-clad optical fiber, according to an example embodiment.

FIG. 12 illustrates an example of a section of an active tapered double-clad optical fiber, according to an example embodiment.

FIG. 13 illustrates an example of a fiber laser device, according to an example embodiment.

FIG. 14 illustrates another example of a fiber laser device, according to an example embodiment.

FIG. 15 illustrates another example of a fiber laser device, according to an example embodiment.

FIG. 16 illustrates another example of a fiber laser device, according to an example embodiment.

FIG. 17 illustrates an example of a fiber master oscillator power amplifier device, according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Example embodiments generally relate to the field of fiber optics. An optical fiber may include a core surrounded by at least one cladding layer having a refractive index lower than the refractive index of the core. Refractive indices of the core and cladding material affect the critical angle for total internal reflection for light propagating in the core. This angle also defines the range of angles of incidence that enable light launched at an end of the optical fiber to propagate within the core. A numerical aperture (NA) of the fiber may be defined as the sine of the largest angle that enables light to propagate within the core. The core may comprise a transparent material such as for example silicon dioxide.

In active optical fibers the core may be doped with at least one rare-earth element. Rare-earth elements comprises a group of materials including cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y). The core of an active optical fiber may be doped with one or more of these elements, for example with Er or Yb, or a combination of Er and Yb. During operation of an active optical fiber the rare-earth ions absorb pump radiation that is launched in the active optical fiber in addition to the optical signal. This enables the optical signal to be amplified by means of stimulated emission. Different rare-earth elements may be used for different wavelengths. For example, Yb may be used for 980-1100 nm wavelength range and Er may be used for 1535-1600 nm wavelength range.

An optical fiber may be configured to support single-mode or multi-mode operation. A single-mode fiber may be configured to carry a single mode of light, which may be understood as a single ray of light propagating through the core of the optical fiber. Single-mode fibers may have a relatively thin core. The single mode regime of propagation is enabled for a step index fiber when so called normalized frequency V < 2.405, where V =

$$\frac{2 π}{λ} r N A$$

=

$$\frac{2 π}{λ} r \sqrt{{n}_{c o r e}^{2} - {n}_{c l a d d i n g}^{2}}$$

where λ is the wavelength, r is the core radius, and NA is the numerical aperture of the core. In multi-mode fibers light may be configured to travel over multiple paths within the core. Single-mode fibers enable lower signal degradation and dispersion and they are therefore suitable for long distance communication, while multi-mode fibers may be less expensive and used for shorter distance communication.

A single-mode fiber may comprise one or more single-mode and multi-mode sections. For example, a single-mode fiber may comprise a tapered section such that at least one thinner portion of the active core may be configured to support single-mode operation, passing only the fundamental mode, while thicker portion(s) of the active core may be configured to support multi-mode operation. However, the single-mode portion of the tapered core may cause also the thicker portion(s) to carry a single-mode optical signal.

Birefringence (B) is an optical property of a material, for example an active core of an optical fiber. A material is birefringent if it has different index of refraction for different directions. Furthermore, for example bending the optical fiber may cause refractive indices in X and Y directions to become slightly different. Birefringent materials have a refractive index that is different for different polarizations of the optical signal. Birefringence may be defined based on a maximum difference between refractive indices for different polarizations: B = 2πΔn, where Δn is the maximum difference between refractive indices for different polarizations (e.g. “fast” and “slow” modes). A linear birefringence may refer to the difference between refractive indices for different linear polarizations of the optical signal. A circular birefringence may refer to the difference between refractive indices for different circular polarizations (left and right) of the optical signal.

According to an example embodiment, a section of an active optical fiber may comprise an active core doped with at least one rare-earth element. The active core may have a first refractive index and be configured to support a single-mode operation of an optical signal. The section of the active optical fiber may further comprise at least one cladding layer having a second refractive index, which may be lower than the refractive index of the active core. A birefringence of the active core may be less than 10⁻⁵. This enables the active optical fiber to provide a sufficiently stable state of polarization even under internal heating caused by the pumping operation. The thermally stable active optical fiber may be used in various applications such as for example fiber lasers and amplifiers.

FIG. 1 illustrates an example of a model of an ideal optical fiber. A model of an ideal optical fiber may comprise a straight fiber with length L. The ideal optical fiber has a perfectly round core 102 and at least one cladding layer 104 aligning strictly axisymmetrically without any mechanical stresses. The X and Y polarized modes E̅ₓ and E̅_{y} propagate through the fiber and at the end of the fiber and they can be formulated as E̅ₓ exp (JβₓL) and E̅_{y} exp(jβ_{y}L). In an ideal fiber the X and Y polarized modes have the same propagation constant βₓ = β_{y} and therefore light with any polarization passes through the ideal fiber without distortion.

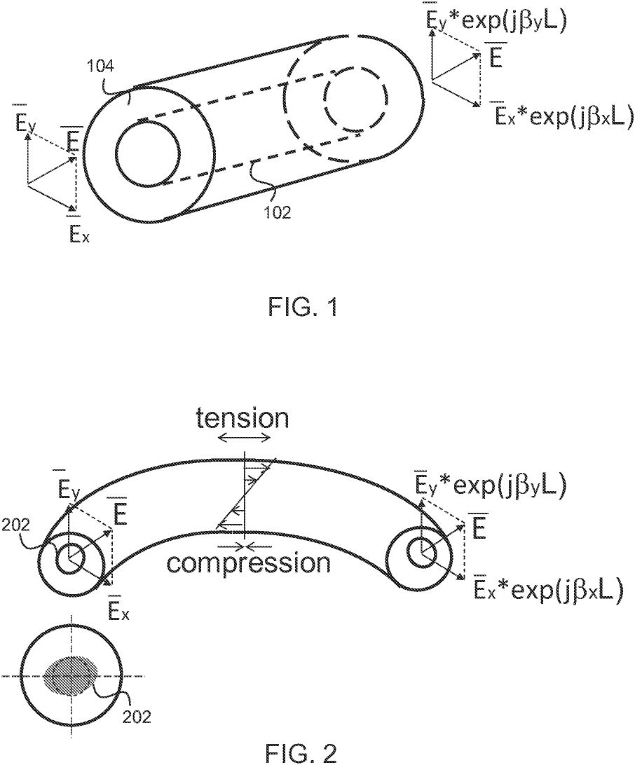

FIG. 2 illustrates an example of a real optical fiber, according to an example embodiment. A real fiber with length L, which may be for example longer than a few centimeters, may be under environmental influences such as for example mechanical vibration, stresses, temperature gradient, or the like. A real fiber may be bent and various parts along the length of the real fiber may be bent differently. This may cause tension and compression along the fiber as illustrated in FIG. 2. Furthermore, a real fiber may not have perfect core and clad geometry. For example, the core 202 of a real fiber may be slightly non-circular and eccentric. In a real fiber the X and Y polarized modes E̅ₓ and E̅_{y} may have different propagation constants βₓ ≠ β_{y}. As a result, the degeneracy of the orthogonal polarization modes regarding the propagation constant may be stripped and therefore different polarization modes may propagate in the fiber with different phase velocities. This may lead to unpredictable state of polarization at the fiber end. Thus, a real single-mode optical fiber may be considered equivalent to a uniaxial crystal. Furthermore, numerous external physical effects such as for example mechanical transverse, longitudinal compressions, different kinds of bends, electric fields, and/or magnetic fields, may create different types of birefringence (linear or circular or in general case, elliptical) in a single-mode optical fiber. Combination of linear and circular birefringence leads to elliptical birefringence.

In order to make the state of polarization of light passing through the optical fiber more stable and predictable, fibers with large intrinsic birefringence may be used. Strong intrinsic birefringence may be obtained based on various means such as for example elliptical core fibers or side-pit fibers comprising stress applying parts, e.g. tension rods or bow-tie glass parts, embedded in the fiber clad. Strong internal birefringence, caused by any suitable method, may exceed the birefringence induced by environmental influences. As a result, intrinsic fiber birefringence makes the fiber less susceptible to environmental influences. Therefore, state of polarization at the output of such fiber remains stable even under environmental influences.

This approach for stabilizing the state of polarization may be suitable for passive optical fibers that are intended to be used for applications in telecommunication and sensor systems. Passive fibers may be long, for example hundreds of kilometers for telecommunication purposes and hundreds of meters in sensing systems, and they may be mainly subject to mechanical perturbations (e.g. bending, stretching, and compression) due to the nature of the application. Stabilizing the state of polarization by strong internal birefringence may be effective for fibers under such mechanical perturbations.

The approach of strong internal birefringence may be also applied for active optical fibers. Examples of such fibers include bow-tie or PANDA (polarization-maintaining and absorption reducing) type of fibers having stress applying parts in the cladding layer at opposite sides of the core.

However, working conditions of active and passive fibers may be very different. Active fibers at a laser or amplifier may be relatively short, for example less than 20 m, well insulated from vibrations, and, contrary to passive fibers, internally heated during operation. For example, there may be two wavelengths propagating in an active optical fiber: a signal wavelength λₛ (subject to amplification) and pump radiation with shorter wavelength λₚᵤₘₚ. The signal may propagate in the core. The pump radiation may propagate in the core or in a cladding layer. Energy equal to the difference between the energy of the pump and signal photons (quantum decay) may be released as heat when a rare-earth ion absorbs a pump photon λₚᵤₘₚ.

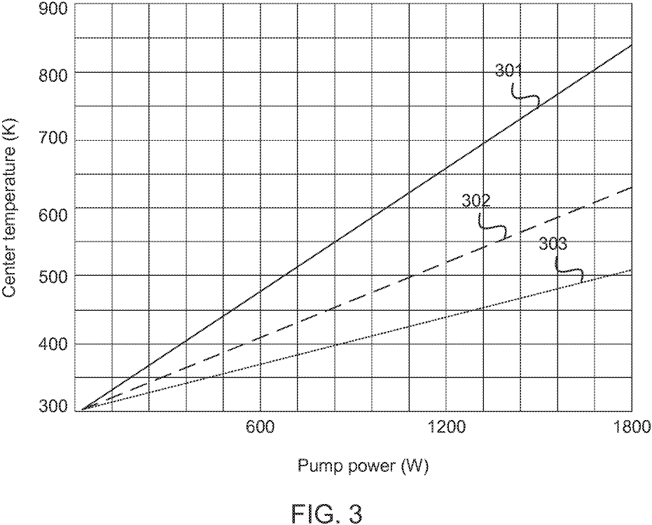

FIG. 3 illustrates an example of a temperature of an active optical fiber with respect to pump power, according to an example embodiment. The solid curve 301 represents fiber center temperature for a fiber having an active core with radius of 4.6 µm, while thickness of the cladding layer is 200 µm. The dashed curve 302 represents fiber center temperature, when the thickness of the cladding layer is 315 µm. The dotted curve 303 represents fiber center temperature, when the thickness of the cladding layer is 500 µm. Convective coefficient is 1 x 10⁻³ W/ (m² K) . As can be seen from FIG. 3, the temperature of the core increases linearly with respect to pump power. Increasing the thickness of the cladding layer reduces the temperature change, but even with the thickest cladding layer 500 µm the temperature change is still significant. Therefore, the internal heating due to pump absorption makes an active optical fiber susceptible to temperature dependent changes.

Retardance in an optical fiber, e.g. the phase shift between “fast” and “slow” waves, may be described by the following equation:

$$R = \frac{2 π Δ n}{λ} L = B L \left[\text{rads}\right]$$

where L is the length of the fiber and B is the normalized birefringence of the fiber (normalized by the wavelength of light λ). This equation also characterizes the state of polarization (SOP). The temperature sensitivity of the retardance, in other words the temperature sensitivity of the state of polarization, may be presented as follows:

$$d R = \left(L \frac{d B}{d T} + B \frac{d L}{d T}\right) Δ T$$

As follows from Equation (2), the temperature sensitivity of the state of polarization depends on the fiber length L, the temperature sensitivity of the birefringence dB/dT, the temperature sensitivity of the fiber length dL/dT, and the absolute value of birefringence B. Thus, temperature sensitivity of the state of polarization of passed light increases as the intrinsic birefringence of the fiber and/or the length of the fiber increases. Thus, exploiting core material with strong internal birefringence may cause unstable state of polarization in active optical fibers. On one hand, active optical fibers are subject to strong heating due to pump absorption (up to hundreds of degrees K), and on the other hand, internal fiber birefringence is highly temperature dependent.

In some applications, the focus may be in the change of the phase of optical radiation, mechanical stresses in the fiber, or deterioration of pump absorption caused by heating of the optical fiber. However, as follows from Equations 1 and 2, heating the fiber may result in a significant change of birefringence. And, a significant change in birefringence may result in a significant change in the state of polarization.

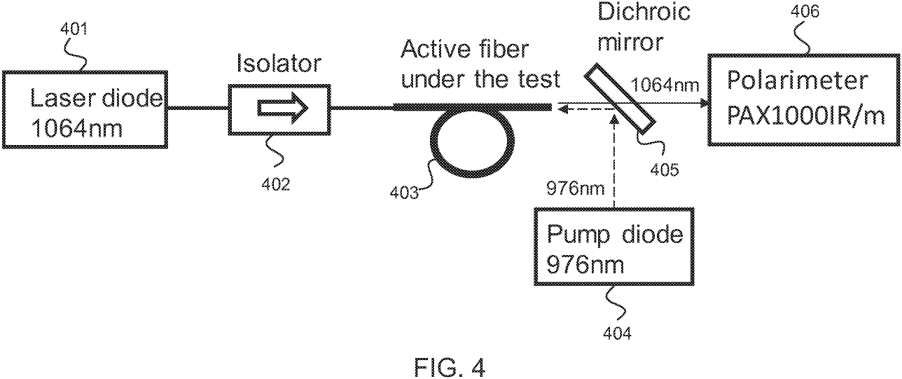

FIG. 4 illustrates a scheme of an experiment for measuring temperature sensitivity of birefringent core materials. The setup comprises a laser diode 401 configured to launch radiation (optical signal) through an isolator 402 into the active fiber 403 under the test. The setup further comprises a pump diode 404 configured to launch pump radiation to the active fiber 403 via a dichroic mirror 405, and a polarimeter 406 (PAX1000IR1/m) for analyzing polarization of the amplified radiation coming out of the active fiber 403.

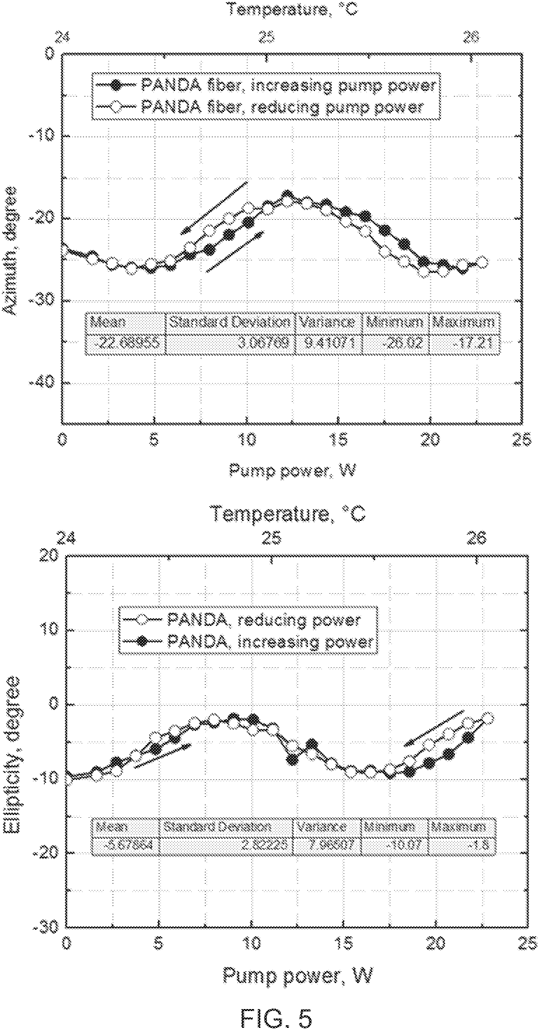

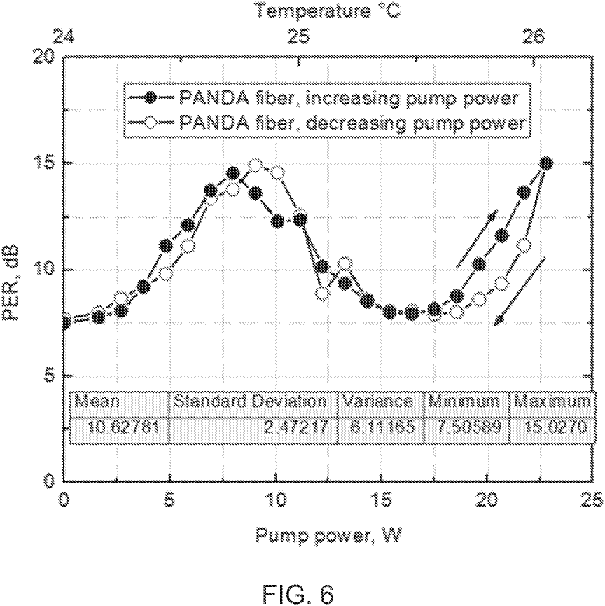

In a first experiment, radiation of a 100% linearly polarized semiconductor fiber-coupled laser diode at 1064 nm was launched (by splicing) into a PANDA type birefringent double clad ytterbium doped tapered fiber such that a single polarization mode (one eigenstate) was excited. Length of the birefringent active tapered fiber was 5 m and the fiber was coiled into 35 cm ring and it had 25 mm polarization beat length. Birefringence of the core was B=0.4*10⁻⁴. The pump radiation at 976 nm wavelength was launched into the cladding of the wide side of the active ytterbium doped tapered fiber by using a lens and the dichroic mirror 405. The state of polarization of the amplified radiation (azimuth, ellipticity, and polarization extinction rate) was analyzed using polarimeter 406. In this experiment, the dependence of the state of polarization of the amplified radiation was measured as a function of the pump power radiation launched into the cladding. The temperature was measured at 5 cm distance from the wide end of the fiber. No special measures were applied to cool the fiber during the experiment. The results are shown in FIG. 5 and FIG. 6.

FIG. 5 illustrates an example of polarization stability and temperature with respect to pump power for the PANDA type active tapered optical fiber. The black dotted line represents the state of polarization with increasing pump power and the white dotted line represents state of polarization with decreasing pump power. As follows from the experimental results, increasing pump power from zero to approximately 22.5 W leads to increasing the fiber temperature by 2° C. (from 24° C. to 26° C.), resulting in periodical changes of the azimuth of SOP with variance 9.41° and standard deviation 3.07° (upper graph). The mean of the azimuth was -22.69° and the minimum and maximum values were -26.02° and -17.21°, respectively. Simultaneously, the ellipticity (lower graph) changed with variance 7.97° and standard deviation of 2.82°. The mean of the ellipticity was -5.68° and the minimum and maximum values were -10.07° and -1.8°, respectively.

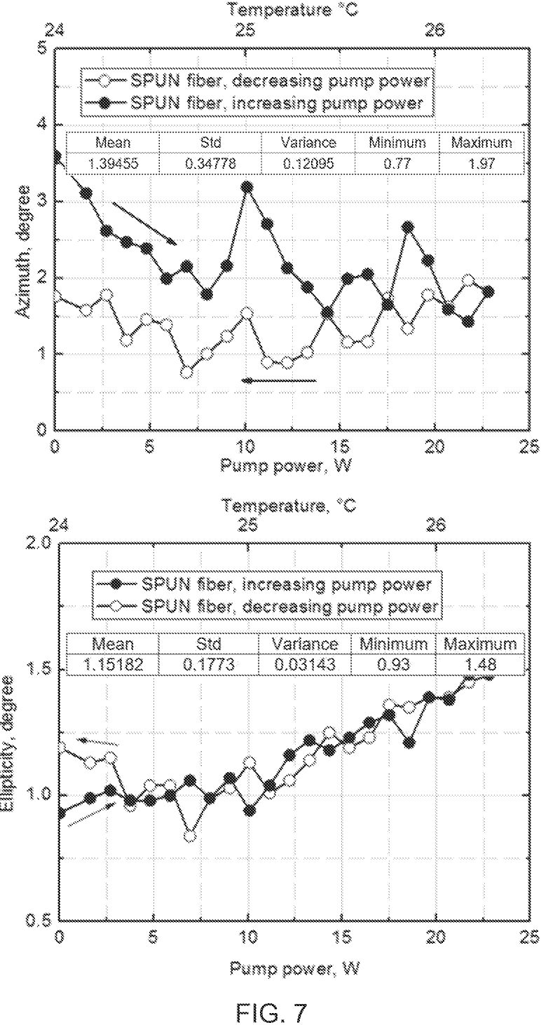

FIG. 6 illustrates an example of polarization extinction rate with respect to pump power for the PANDA type active tapered optical fiber. Polarization extinction rate (PER) is a measure that compares the power of the desired polarization to the power of the undesired polarization. As illustrated in FIG. 7, the PER changes with variance of 6.11 dB and standard deviation of 2.47 dB when temperature of the fiber changes only 2° C. The mean of the PER was 10.63 dB and the minimum and maximum values were 7.51 dB and 15.03 dB, respectively.

Based on the differences between state of polarizations with increasing and decreasing pump power, the changes in the state of polarization may occur with hysteresis and therefore such active fibers with stress induced birefringence exhibit memory regarding to the launched pump power history. Based on this measurement it is observed that the internal heating due to a 22 W pump power absorption causes drift of the state of polarization.

Therefore, following observations can be made based on the experiment: 1) The state of polarization of the amplified light in an active fiber with a strong birefringence is significantly dependent on the launched pump power, and 2) the state of polarization varies with hysteresis and has a memory relative to the history of the launched pump power. This makes behavior of the state of polarization unpredictable.

Based on Equation 2, if the intrinsic birefringence is small (B→0) then (dB/dt)*ΔT << B, and as a result, the temperature sensitivity of the state of polarization tends to go to zero (i.e., dR→0 ). Hence, the smaller the intrinsic birefringence of a fiber, the lower the polarization sensitivity of the fiber. For example, the retardance will change less during fiber pumping. By contrast, highly birefringent fibers may be strongly temperature sensitive.

Strong temperature sensitivity causes birefringence to change dramatically as the temperature changes. Additionally, as discussed above, the changes of internal birefringence happen irreversibly, with hysteresis. Both increasing and decreasing of internal birefringence are possible during annealing. Since birefringence variations occur with hysteresis, highly birefringent fibers have a memory of birefringence with respect to the history of fiber heating. Nevertheless, due to the nature of applications (e.g. transparent medium for a light transmission), highly birefringent optical fibers may not be exposed to significant temperature changes, and therefore the above mentioned properties do not generally impede their exploitation, for example as passive optical fibers or active optical fiber with relatively low pump power.

Fibers with low intrinsic birefringence may be manufactured in various ways. One way to obtain low intrinsic birefringence is to make the optical fiber as close to ideal as possible, for example, by making the fiber extremely symmetrical with a low level of internal stresses. Another way for obtaining low intrinsic birefringence is to apply compensated fibers. A low level of internal birefringence can be achieved for example by selecting the fiber dopant materials such that a stress birefringence (Bₛ) together with a geometrical shape birefringence (B_{c}) add to zero. Yet another way for obtaining low intrinsic birefringence is to use spun fibers. If fiber preform is rapidly spun while pulling the fiber, the internal birefringence becomes low. Spinning the preform periodically interchanges the fast and slow birefringence axes along the fiber, leading to piecemeal compensation of the relative phase delay between the polarization eigenmodes.

According to an example embodiment, an active optical fiber with low intrinsic birefringence is provided. SOP stability of such fiber was verified with the experiment setup of FIG. 4. An Yb-doped spun active double clad tapered fiber was manufactured for experimental verification of SOP stability. To manufacture the spun fiber, the fiber preform was rotated with angular velocity 600 rev/min during the pulling of the active tapered fiber. In this experiment, emission from the linearly polarized semiconductor laser at 1064 nm was launched by splicing via fiber coupled isolator 402 into the spun tapered fiber. The length of the spun tapered fiber was 2.8 m and it had 6 mm pitch in the wide part. Pitch may refer to a period of rotation, e.g. length over which the spun fiber rotates 360°. The pitch may be dependent on the velocity of pulling the fiber and angular velocity of the rotation. The residual linear birefringence of the fiber was 3.21*10⁻⁶ and circular birefringence 6.88*10⁻⁶. The fiber was coiled into a ring with a 35 cm diameter. Pump radiation at 976 nm was launched into a clad of the active fiber via the lens and the dichroic mirror 405.

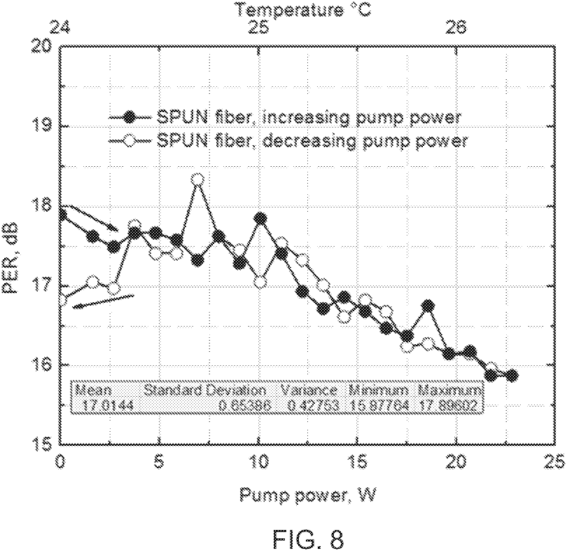

The state of polarization (azimuth, ellipticity and PER) of the amplified radiation was analyzed by using polarimeter 405. The dependence of the state of polarization of the amplified radiation was again investigated as a function of the launched pump power. No measures to force cooling the fiber during the experiment were applied. The results are shown in FIG. 7 and FIG. 8.

FIG. 7 illustrates an example of polarization stability and temperature with respect to pump power for the spun active tapered optical fiber. As follows from the experimental results, increasing pump power from zero to approximately 20 W leads to increasing the fiber temperature by 2° C. (from 24° C. to 26° C.), resulting in periodical changes of the azimuth with variance 0.12° and standard deviation 0.35° (upper graph). The mean of the azimuth was 1.39° and the minimum and maximum values were 0.77° and 1.97°, respectively. Simultaneously, the ellipticity (lower graph) changed with variance 0.03° and standard deviation of 0.18°. The mean of the ellipticity was 1.15° and the minimum and maximum values were 0.93° and 1.48°, respectively.

FIG. 8 illustrates an example of polarization extinction rate with respect to pump power for the spun active tapered optical fiber. As illustrated in FIG. 8, the PER changes with variance of 0.43 dB and standard deviation of 0.65 dB when temperature of the fiber changes 2° C. The mean of the PER was 17.01 dB and the minimum and maximum values were 15.88 dB and 17.90 dB, respectively.

Based on the results of FIG. 5 to FIG. 8 the changes in the state of polarization the active spun fiber are significantly lower for the low birefringence spun fiber compared to the PANDA type fiber. Table 1 contains comparative data for PANDA type fiber and the spun fiber. As can be observed from Table 1, stability of the state of polarization, e.g. deviation of azimuth and ellipticity, is one order better for the spun active tapered fiber. Variance of ellipticity is better even on two orders

TABLE 1

Comparison of SOP variation for PANDA and spun active fibers (22W pump power)

| | PANDA | SPUN |
|---|---|---|
| Standard deviation of azimuth (degrees) | 3.07 | 0.35 |
| Variance of azimuth (degrees) | 9.41 | 0.12 |
| Standard deviation of ellipticity (degrees) | 2.82 | 0.18 |
| Variance of ellipticity (degrees) | 7.97 | 0.03 |
| Standard deviation of PER (dB) | 2.47 | 0.65 |
| Variance of PER (dB) | 6.11 | 0.43 |

The above experiments demonstrate that the active optical fiber with low birefringence is significantly better in terms of SOP stability compared to the amplifier with highly birefringent fiber such as for example a PANDA type fiber.

Example embodiments provide different types of active optical fibers that enable a stable state of polarization, which is sufficiently independent from launched pump power. Example embodiments provide for example sections of single-clad or double-clad active optical fibers with or without a tapered longitudinal profile in combination with low intrinsic birefringence at the core. According to an example embodiment, a birefringence of the active core may be less than 10⁻⁵. According to an example embodiment, a linear birefringence of the active core may be less than 10⁻⁵. According to an example embodiment, a circular birefringence of the active core may be less than 10⁻⁵. According to an example embodiment, both the circular and the linear birefringence of the active core may be less than 10⁻⁵. Based on experiments, birefringence value (s) less than 10⁻⁵ may provide a sufficiently stable state of polarization for temperature changes due to internal heating of an active optical fiber. In general, stability of the state of polarization may be improved by lowering the birefringence. For example, birefringence value(s) less than 10⁻⁵, for example in the range of 10⁻⁶<B<10⁻⁵, may provide even more stable state of polarization, which may be beneficial for example with longer fiber length L or higher pump power. According to an example embodiment, birefringence of the active core may be according to the active spun fiber described in relation with FIG. 6 and FIG. 7. For example, linear birefringence of the active core may be 3.2*10⁻⁶. Circular birefringence of the active core may be 6.7*10⁻⁶.

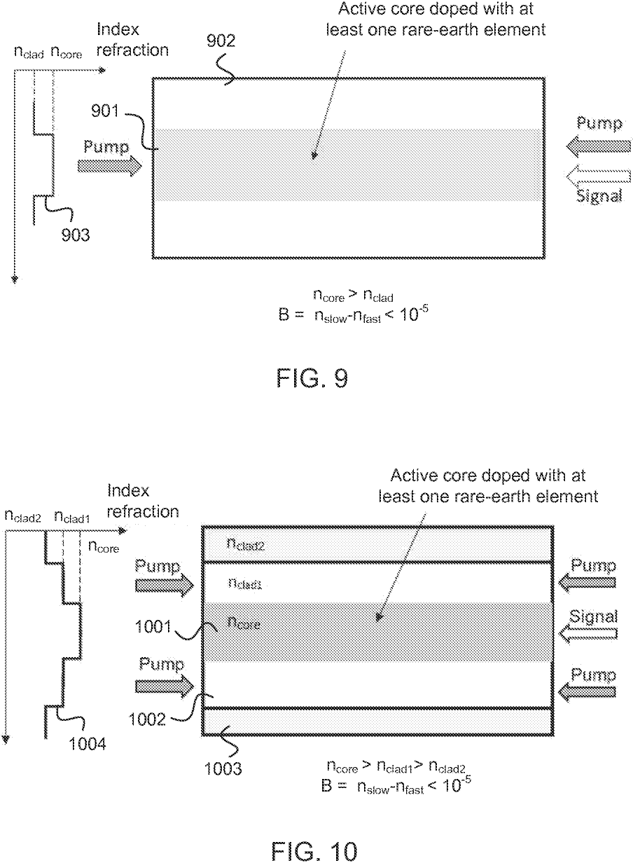

FIG. 9 illustrates an example of a longitudinal cross-section of an active single-clad optical fiber, according to an example embodiment. The section of the active optical fiber may comprise an active core 901. The core may comprise any suitable material such as for example silicon dioxide. The active core 901 may further comprise at least one rare-earth element. The active core 901 may be doped with the rare-earth element(s) in order to enable amplification of an optical signal launched in the active core 901, when pump radiation is launched in the active core 901. The section of the active optical fiber may further comprise a cladding layer 902. The active core 901 may have a first refractive index n_{core}. The cladding layer 902 may have a second refractive index, n_{clad}. The second refractive index n_{clad} may be less than the first refractive index n_{clad}, as illustrated in the refractive index profile 903 of the cross-section. Birefringence of the active core may be less than 10⁻⁵, as described above. For example, difference between the refractive indices n_{slow} and n_{fast} of the slow and fast polarization modes may be smaller than 10⁻⁵, that is, B=n_{slow}-n_{fast}<10⁻⁵.

The active core 901 may be configured to support a single-mode operation. For example, the active core 901 may satisfy a propagation condition for the single mode operation of the optical signal. The propagation condition may comprise 2πrNA/λ<2.405, wherein r is the radius of the active core, NA is the numerical aperture of the active core, and A is the wavelength of the optical signal. As illustrated in FIG. 9, the active core 901 may be configured to receive the optical signal and the pump radiation. In other words, the optical signal may be launched at the active core 901, for example at one end of the active core 901. The pump radiation may be configured to be received or be launched at either or both ends of the section of the active core 901.

FIG. 10 illustrates an example of a longitudinal cross-section of an active double-clad optical fiber, according to an example embodiment. The section of the active optical fiber may comprise an active core 1001. The active core 1001 may have a first refractive index, n_{core}. The section of the active optical fiber may further comprise an inner cladding layer 1002 around the active core 1001. The inner cladding layer 1002 may have a second refractive index n_{clad1}. The section of the active optical fiber may further comprise an outer cladding layer 1003 around the inner cladding layer 1002. The outer cladding layer 1003 may have a third refractive index, n_{clad2}. The first refractive index n_{core} may be less than the second refractive index n_{clad}, and the third refractive index n_{clad2} may be less than the second refractive index n_{clad1}, as illustrated in the refractive index profile 1004 of the cross-section. Birefringence of the active core 1001 may be less than 10⁻⁵. The active core 1001 may be configured to receive the optical signal. In other words, the optical signal may be launched at the active core 1001. The inner cladding layer 1002 may be configured receive pump radiation from either or both ends of the section of the active optical fiber. In other words, the pump radiation may be launched at either or both ends of the section of the active optical fiber into the inner cladding layer 1002.

Low birefringence of the active core improves tolerance to internal heating caused by the pumping operation. Having a low birefringence in a non-tapered single-mode active core may be beneficial, because the relatively thin single-mode core may be more susceptible to internal heating due to pump power than a wider multi-mode core. For example, having a single-mode core with a smaller diameter results in a smaller surface area, which in turn, defines the ability to dissipate heat. Low birefringence at the single-mode core therefore enables higher power of pump radiation to be launched in the single-mode fiber and therefore enables better amplification of the optical signal, while maintaining sufficiently stable state of polarization.

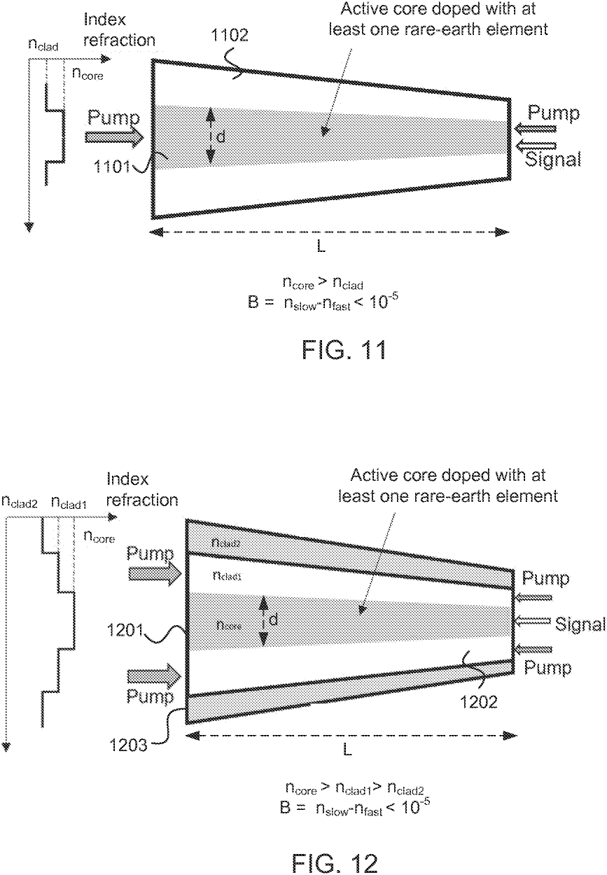

FIG. 11 illustrates an example of a longitudinal cross-section an active tapered single-clad optical fiber, according to an example embodiment. The section of the active optical fiber may comprise an active core 1101 and a cladding layer 1102, which may be similar to active core 901 and cladding layer 902 of FIG. 9. However, the section of the active optical fiber may have a tapered longitudinal profile such that a diameter d of the active core 1101 may change gradually along a length L of the section of the active optical fiber, thereby forming the tapered longitudinal profile. As a result, the section of the active optical fiber may comprise a first portion and a second portion, where the radius of the first portion of the active core is less than the radius of a second portion of the active core. Furthermore, the thickness of the cladding layer 1102 may change gradually along the tapered longitudinal profile. For example, the thickness of the cladding layer 1102 may be proportional to the diameter d of the corresponding portion of the active core 1101.

The first portion of the active core may be configured to satisfy the propagation condition for the single mode operation of the optical signal. The rest of the active core, for example the second portion may be configured to support multi-mode operation of the optical signal. The propagation condition may comprise 2nrNA/A < 2.405, wherein r is the radius (d/2) of the first portion the active core, NA is the numerical aperture of the first portion of the active core, and A is the wavelength of the optical signal. The first portion of the active core may be configured to receive the optical signal. In other words, the optical signal may be launched at the first portion of the active core 1101. The first portion and/or the second portion of the active core 1101 may be configured to receive pump radiation. In other words, pump radiation may be launched at the first portion and/or the second portion of the active core 1101.

According to an example embodiment, the first portion of the active core 1101 may be located at a first end of the section of the active optical fiber and the second portion of the active core 1101 may be located at a second end of the section of the active optical fiber. According to an example embodiment, the first portion of the active core 1101 may comprise a narrow end of the active core 1101. The second portion of the active core 1101 may comprise a wide end of the active core 1101.

Launching the optical signal at the first portion of the tapered active core 1101 enables to arrange propagation of only the fundamental mode also in the second (multi-mode) portion of the active core 1101. The larger diameter of the second portion of the active core 1101 allows launching pump radiation from high-power low-intensity pump sources with high efficiency into the active tapered fiber. Low birefringence of the tapered core of an active optical fiber enables to benefit from the higher pump power launching capability of the second portion, while maintaining sufficiently stable state of polarization for the single-mode optical signal. According to an example embodiment, approximately 90% of the pump radiation may be launched into the second portion of active core 1101, for example in order to achieve desired gain with low nonlinearities. Approximately 10% of the pump radiation may be launched into the first portion of active core 1101, for example to cause saturation of the active core 1101.

FIG. 12 illustrates an example of a longitudinal cross-section an active tapered double-clad optical fiber, according to an example embodiment. The section of the active optical fiber may comprise an active core 1201, an inner cladding layer 1202, and an outer cladding layer 1203 similar to the active core 1001 and cladding layers 1002 and 1003 of FIG. 10. However, the section of the active optical fiber may have a tapered longitudinal profile. For example, the diameter d of the active core 1201 may change gradually along the length L of the section of the active tapered optical fiber. Furthermore, the thickness of the inner and/or outer cladding layer may change gradually along the tapered longitudinal profile. For example, the thickness of the inner and/or outer cladding layer may be proportional to the diameter d of the corresponding portion of the active core 1201.

According to an example embodiment, the active core 1201 may comprise first and second portions similar to active core 1101 of FIG. 11. According to an example embodiment, the section of the active optical fiber may comprise a first portion of the inner cladding layer 1202 around the first portion of the active core 1201 and a second portion of the inner cladding layer 1202 around the second portion of the active core 1201. The thickness of the first portion of the inner cladding layer 1202 may be less than the thickness of the second portion of the inner cladding layer 1202. The first portion and/or the second portion of the inner cladding layer 1202 may be configured to receive the pump radiation. In other words, the pump radiation may be launched at the first portion and/or the second portion of the inner cladding layer 1202. The larger thickness of the second portion of the inner cladding layer 1202 allows launching higher power pump radiation into the tapered fiber. Low birefringence of a tapered core of an active optical fiber enables to benefit from the higher pump power launching capability of the second portion of the inner cladding layer 1202, while maintaining sufficiently stable state of polarization for the single-mode optical signal.

According to an example embodiment, the first portion of the inner cladding layer 1202 may be located at a first end of the section of the active optical fiber and the second portion of the inner cladding layer 1202 may be located at a second end of the active optical fiber. According to an example embodiment, the first portion of the inner cladding layer 1202 may comprise a narrow end of the inner cladding layer. The second portion of the inner cladding layer 1202 may comprise a wide end of the inner cladding layer.

Even though not illustrated in FIGS. 9 to 12, the section of the active optical fiber may further comprise additional structures such as for example one or more coating layers around the cladding layer(s). The coating layer(s) may for example comprise polymer coating. The coating layer(s) may be configured to reduce environmental influences that may cause external birefringence to be introduced at the active core 901, 1001, 1101, 1201 having a low intrinsic birefringence. Therefore, the low internal birefringence coupled with one or more coating layers together provide an active optical fiber that provides a sufficiently stable state of polarization under changing (internal/external) temperature and other environmental influences such as mechanical bending. In the above example embodiments, the pump radiation may be configured to propagate in a same or substantially same direction as the optical signal and/or in opposite or substantially opposite direction to the optical signal.

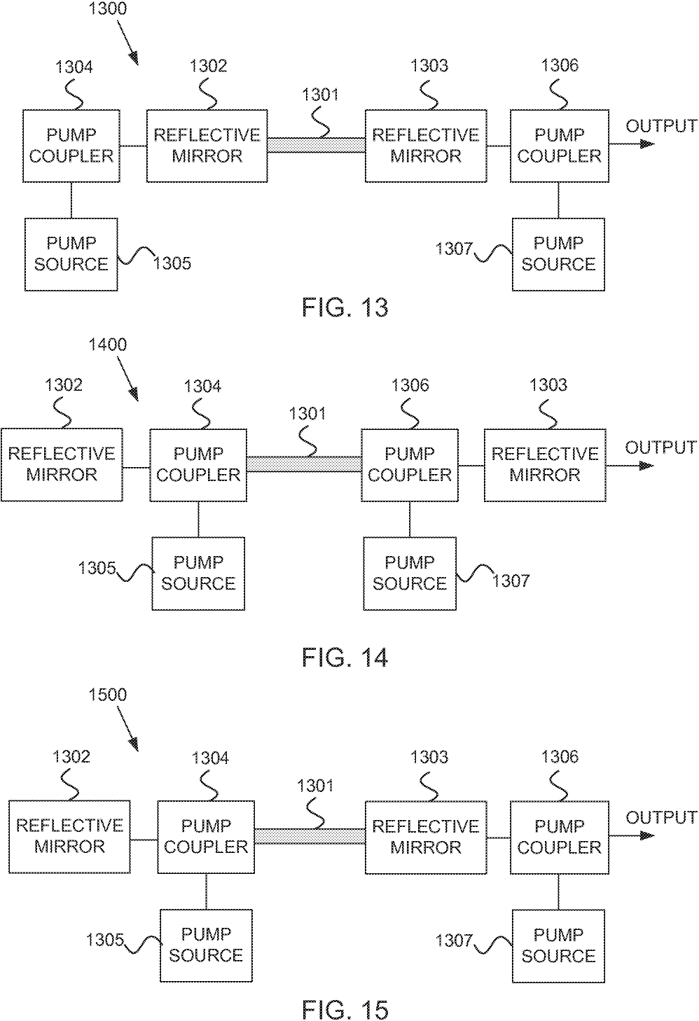

FIG. 13 illustrates an example of a fiber laser device 1300, according to an example embodiment. The fiber laser device 1300 may comprise an active optical fiber 1301. The active optical fiber 1301 may comprise any of the different types of active optical fibers, or section(s) thereof, described above. The fiber laser device 1300 may be configured to provide output radiation that has been amplified inside the active optical fiber 1301 while bouncing back and forth between a pair of reflective mirrors. The fiber laser device 1300 may comprise a pump radiation source 1305. The pump radiation source may be optically connected to a pump radiation coupler 1304. The pump radiation source may be configured to generate pump radiation with an appropriate power. The pump radiation coupler 1304 may be configured to couple radiation from the pump radiation source 1305 to the active optical fiber 1301. The pump radiation coupler 1304 may for example comprise a multimode pump combiner, a free space lens system, and/or a wavelength dependent multiplexer (WDM) for single clad fibers. The multimode pump combiner may be of type (1+n)*1, which may indicate that one input signal fiber and n pump fibers are combined together, for example by tapering, into one signal output fiber. An example of such multimode pump combiner is a (1+6)*1 combiner, which combines together six pump fibers and one signal fiber. The pump radiation coupler 1304 may be configured to launch the pump radiation into appropriate portion and/or layer of the active optical fiber 1301. For example, in case of a single-clad fiber the pump radiation coupler 1304 may be configured to launch the pump radiation originating from pump source 1305 into the core of the active optical fiber 1301. In case of a double-clad fiber the pump radiation coupler 1304 may be configured to launch the pump radiation originating from pump source 1305 into the core of the active optical fiber 1301. The pump radiation coupler 1304 may be optically connected to a first end of the active optical fiber 1301. Being optically connected may enable light to propagate between two optically connected or optically coupled components. An optical connection may comprise a direct optical connection such that there are no intermediate components, such as for example mirrors or pump radiation couplers, between the optically connected components.

The fiber laser device 1300 may further comprise a second pump radiation source 1307 and a second pump radiation coupler 1306, which may be similar to pump coupler 1304 and pump radiation source 1305, respectively. However, the pump radiation coupler 1306 may be optically connected to a second end, e.g. output end, of the active optical fiber 1301. Furthermore, the pump radiation source 1307 may be configured to generate pump radiation having a different power level compared to the pump radiation originating from pump radiation source 1305. For example, in case of an active tapered optical fiber, the pump radiation source may be optically connected to the first end of the active optical fiber 1301, which may be thinner than the second end of the active optical fiber 1301. Power level of the second pump radiation source 1307 may be higher than the power level of the pump radiation source 1305, as described above.

The fiber laser device 1300 may further comprise a first reflective mirror 1302, which may be optically connected to a first end of the active optical fiber 1301. The first reflective mirror 1302 may be configured to convey pump radiation from pump coupler 1304 to the active optical fiber 1301. The first reflective mirror 1302 may be configured to reflect majority of light propagating towards it in the active optical fiber 1301. The first reflective mirror 1302 may for example comprise a free space bulk dielectric or metal coated mirror, fiber Bragg grating (FBG) written at another optical fiber spliced to the first end of the active optical fiber 1301, a fiber loop mirror, or a fiber coupled Faraday rotated mirror. Alternatively, the fiber Bragg grating may be written at the first end of the active optical fiber 1301. Reflectivity of the first reflective mirror may be for example greater than 90%.

The fiber laser device 1300 may further comprise a second reflective mirror 1303, which may be optically connected to a second end, e.g. output end, of the active optical fiber 1301. The second reflective mirror 1303 may be configured to convey pump radiation from pump coupler 1306 to the active optical fiber 1301. The second reflective mirror 1303 may be configured to pass part of light propagating towards it in the active optical fiber to enable outputting the amplified light from the fiber laser device 1300. The second reflective mirror 1303 may for example comprise a free space bulk dielectric or metal coated mirror, fiber Bragg grating (FBG) written or spliced to the second end of the active optical fiber 1301, or a fiber loop mirror. Reflectivity of the second reflective mirror may be for example less than 90%.

FIG. 14 illustrates another example of a fiber laser device 1400, according to an example embodiment. The fiber laser device 1400 may comprise components similar to the fiber laser device 1300. However, some of the components may be arranged in a different order. For example, the first reflective mirror 1302 may be optically connected to the pump radiation coupler 1304 and the pump radiation coupler 1304 may be optically connected to the first end of the active optical fiber 1301. Furthermore, the second reflective mirror 1303 may be optically connected to the pump radiation coupler 1306 and the pump radiation coupler 1306 may be optically connected the second end of the active optical fiber 1301. Pump radiation couplers 1304 and 1306 may be configured to convey light such that it may be reflected between reflective mirrors 1302 and 1303 to enable amplification of the light at the active optical fiber 1301.

FIG. 15 illustrates another example of a fiber laser device 1500, according to an example embodiment. The fiber laser device 1500 may comprise components similar to the fiber laser device 1300. However, some of the components may be arranged in a different order. In this example, the first reflective mirror 1302 may be optically connected to the pump radiation coupler 1304 and the pump radiation coupler 1304 may be optically connected to the first end of the active optical fiber 1301, similar to FIG. 14. At the output side, the second reflective mirror 1303 may be optically connected to the second end of the active optical fiber 1301 and pump radiation coupler 1306 may be coupled to the second reflective mirror 1303, similar to FIG. 13.

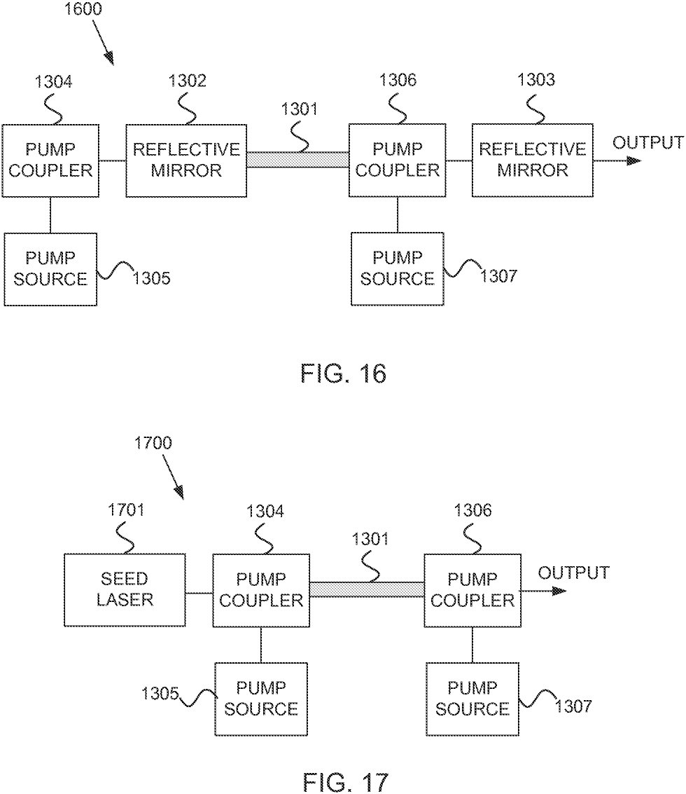

FIG. 16 illustrates another example of a fiber laser device 1600, according to an example embodiment. The fiber laser device 1500 may comprise components similar to the fiber laser device 1300. However, some of the components may be arranged in a different order. In this example, the first reflective mirror 1302 may be optically connected to the pump radiation coupler 1304 and the pump radiation coupler 1304 may be optically connected to the first end of the active optical fiber 1301, similar to FIG. 13. At the output side, the second reflective mirror 1303 may be optically connected to the second end of the active optical fiber 1301 and the pump radiation coupler 1306 may be coupled to the second reflective mirror 1303.

FIG. 17 illustrates an example of a fiber master oscillator power amplifier device (MOPA) 1700, according to an example embodiment. The fiber master oscillator power amplifier device 1700 may comprise any of the different types of active optical fibers, or section(s) thereof, as described above. Furthermore, the fiber master oscillator power amplifier device 1700 may comprise a pump radiation source 1305 and/or a pump radiation source 1307 similar to those of FIG. 13. The fiber master oscillator power amplifier device 1700 may further comprise a pump radiation coupler 1304 and/or a second pump radiation coupler 1306 similar to those of FIG. 13. The pump radiation coupler 1304 may be coupled to a first end of the active optical fiber 1301 and be configured to launch pump radiation originating at pump radiation source 1305 at the active optical fiber 1301. The second pump radiation coupler 1306 may be optically connected to a second end of the active optical fiber 1301 and be configured to launch pump radiation originating at pump radiation source 1307 at the active optical fiber 1301. The second pump radiation coupler 1306 may be further configured to provide output radiation from the active optical fiber 1301. The fiber master oscillator power amplifier device 1700 may further comprise a seed laser source 1701 optically connected to the pump radiation coupler 1304. The seed laser source 1701 may be configured to provide a seed laser signal for amplification at the active optical fiber 1301. The pump coupler 1304 may be configured to couple light form the seed laser source 1701 to the active optical fiber 1301.

Example embodiments provide a thermally stable section of an active optical fiber that may be used in various applications such as for example fiber lasers and fiber master oscillator power amplifiers, for example to enable higher gain enables by higher tolerance to pump radiation induced internal heating.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The term ‘comprising’ is used herein to mean including the blocks or elements identified, but that such blocks or elements do not comprise an exclusive list. An apparatus may therefore contain additional blocks or elements.

Although subjects may be referred to as ‘first’ or ‘second’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1-19. (canceled)

20. A section of an active optical fiber for amplification of an optical signal, comprising:
an active core doped with at least one rare-earth element, the active core having a first refractive index and being configured to support a single mode operation of the optical signal;
at least one cladding layer having a second refractive index, wherein the second refractive index is less than the first refractive index, wherein a birefringence of the active core is less than 10⁻⁵, and wherein a diameter of the active core changes gradually along a length of the section of the active optical fiber forming a tapered longitudinal profile.

21. The section of the active optical fiber according to claim 20, wherein the at least one cladding layer comprises an inner cladding layer around the active core, the inner cladding layer having the second refractive index, and an outer cladding layer around the inner cladding layer, the outer cladding layer having a third refractive index less than the second refractive index.

22. The section of the active optical fiber according to claim 20, wherein a radius of a first portion of the active core is less than a radius of a second portion of the active core.

23. The section of the active optical fiber according to claim 22, wherein the first portion of the active core satisfies a propagation condition for the single mode operation of the optical signal, and wherein the second portion of the active core supports multimode operation of the optical signal.

24. The section of the active optical fiber according to claim 23, wherein the propagation condition comprises 2πcrNA/λ < 2.405, wherein r is the radius of the first portion the active core, NA is a numerical aperture of the first portion of the active core, and λ, is a wavelength of the optical signal.

25. The section of the active optical fiber according to claim 22, wherein the first portion of the active core is configured to receive the optical signal.

26. The section of the active optical fiber according to claim 22, wherein the first portion of the active core is configured to receive pump radiation, and/or wherein the second portion of the active core is configured to receive the pump radiation.

27. The section of the active optical fiber according to claim 22, wherein the active core is configured to receive the optical signal and wherein the inner cladding layer is configured to receive pump radiation.

28. The section of the active optical fiber according to claim 20, wherein a thickness of the inner cladding layer changes gradually along the tapered longitudinal profile.

29. The section of the active optical fiber according to claim 28, further comprising:
a first portion of the inner cladding layer around the first portion of the active core and a second portion of the inner cladding layer around the second portion of the active core, wherein a thickness of the first portion of the inner cladding layer is less than a thickness of the second portion of the inner cladding layer.

30. The section of the active optical fiber according to claim 29, wherein the first portion of the inner cladding layer is configured to receive the pump radiation, and/or wherein the second portion of the inner cladding layer is configured to receive the pump radiation.

31. The section of the active optical fiber according to claim 22, wherein the first portion of the active core comprises a narrow end of the active core and wherein the second portion of the active core comprises a wide end of the active core.

32. The section of the active optical fiber according to claim 29, wherein the first portion of the inner cladding layer comprises a narrow end of the inner cladding layer and wherein the second portion of the inner cladding layer comprises a wide end of the inner cladding layer.

33. The section of the active optical fiber according to claim 26, wherein the pump radiation is configured to propagate in a substantially same direction as the optical signal and/or in a substantially opposite direction to the optical signal.

34. An apparatus comprising the section of the active optical fiber according to claim 20, further comprising:
at least one pump radiation source optically connected to at least one pump radiation coupler, wherein the pump radiation coupler is configured couple radiation from the pump radiation source to the active optical fiber.

35. The apparatus according to claim 34, wherein the apparatus comprises a fiber laser device, further comprising:
a first reflective mirror optically connected to a first end of the active optical fiber or to a first pump radiation coupler optically connected to the first end of the active optical fiber.

36. The apparatus according to claim 35, further comprising a second reflective mirror optically connected to a second end of the active optical fiber or to a second pump radiation coupler optically connected to the second end of the active optical fiber.

37. The apparatus according to claim 34, wherein the apparatus comprises a fiber master oscillator power amplifier, further comprising:
a seed laser source optically connected to the pump coupler, wherein the pump coupled is configured to couple light form the seed laser source to the active optical fiber.
